(19) United States
(12) Patent Application Publication
(10) Pub. No.: US 2024/0275329 A1
(43) Pub. Date: Aug. 15, 2024

(54) SYSTEMS AND METHODS FOR PROVIDING A SOLAR POWER CONTAINER INTEGRATED WITH DISTRIBUTED LEDGER TECHNOLOGY

(71) Applicant: Solar Coin, Bonita Springs, FL (US)

(72) Inventor: Blake Kennedy, Bonita Springs, FL (US)

(21) Appl. No.: 18/437,806

(22) Filed: Feb. 9, 2024

Related U.S. Application Data
(60) Provisional application No. 63/444,749, filed on Feb. 10, 2023.

(51) Int. Cl. H02S 30/10; G06Q 20/06; G06Q 20/36; G06Q 20/42; H02S 40/32; H02S 40/42; H04L 9/00

(52) U.S. Cl. CPC H02S 30/10; G06Q 20/065; G06Q 20/367; G06Q 20/42; H02S 40/32; H02S 40/42; H04L 9/50; H04L 2209/56

(57) ABSTRACT

The disclosed systems and methods relate to an improved solar power container with distributed ledger technology. The container can include a top frame, a lower frame, two sidewalls, and a rack. Each sidewall can be connected to one of the top frame or the lower frame; and the rack can be located between the two sidewalls and connected to one of the top frame or the lower frame. The at least one of the top frame, the two sidewalls, or combinations thereof can include a solar panel, and the rack can include a node and a series of transformers configured to mine cryptocurrencies.

### CROSS-REFERENCE TO RELATED APPLICATIONS

This application claims the benefit, under 35 U.S.C. § 119(e), of U.S. Provisional Patent Application No. 63/444,749, filed 10 Feb. 2023, the entire contents and substance of which are incorporated herein by reference in their entirety as if fully set forth below.

### TECHNICAL FIELD

Aspects of the present disclosure relate to an improved container for collecting solar power and mining blockchains for cryptocurrency to be used with distributed ledger technology and methods related to the same.

### BACKGROUND

Distributed ledger technology (e.g., blockchain technology) has recently been the focus of technical development. Distributed ledger technology has found its way into many areas of life and technical fields. The field of solar power for residential buildings has significant cost, barrier to entry, and return on investment limitations for both the purchasing customer and the solar leasing merchant. Customers wish to maximize the return and minimize the costs to offset the often-large initial capital investment of converting to solar power. As described herein, one way to help minimize costs and improve the overall efficiency of residential solar installations is through the use of distributed ledger technology.

Generally, distributed ledgers operate using a plurality of nodes allowing for exchanges or transactions between the nodes. The nodes are able to verify batches of transactions. In the example of the blockchain, the nodes are able to validate the blocks in the decentralized ledger. Nodes typically can include a central processing unit that can handle data transfer speeds of typical computers, tablets, smart phones, and the like. These and other problems are addressed by the technology disclosed herein.

### SUMMARY

Accordingly, the inventors of this disclosure have recognized that there is a need for the following solution. Embodiments of the present disclosure address these concerns as well as other needs that will become apparent upon reading the description below in conjunction with the drawings. Briefly described, aspects of the present disclosure relate to an improved solar power systems for collecting solar power through solar panels for mining blockchains, and more particularly, for maximizing returns and minimizing costs for users of the solar power system by utilizing mined cryptocurrency.

One aspect of the present disclosure provides a solar power container and method of use. The solar power container can include a top frame, a lower frame, two sidewalls, and a rack. Each sidewall can be connected to one of the top frame or the lower frame; and the rack can be located between the two sidewalls and connected to one of the top frame or the lower frame. The at least one of the top frame, the two sidewalls, or combinations thereof can include a solar panel, and the rack can include a node and a series of transformers configured to mine cryptocurrencies. The solar panel can be mounted to at least one of the top frame, one of the two sidewalls, or combination thereof. The solar panel can be configured to convert sunlight into direct current electricity. A plurality of inverters can be configured to convert the direct current electricity from the solar panel to alternating current electricity. The node can be a plurality of nodes and the plurality of nodes can be configured to generate transactions for a linked distributed ledger network. At least a portion of the plurality of nodes can be attached to at least one of the two sidewalls, the rack, the plurality of inverters, or combinations thereof. The linked distributed ledger network can include a cold storage configured to store cryptocurrency mined from the plurality of nodes. The container can further include two end walls, and each end wall can be connected to one of the top frame or the lower frame. At least one of the end walls can include the solar panel, a door hingeably connected to a door frame of at least one of the end walls, fans, or combinations thereof. At least one of the top frame, the two sidewalls, the two end walls, or combinations thereof can further include insulation, inlet shutters, cooling pads, fans, or combinations thereof.

Another aspect of the present disclosure provides a solar power container. The solar power container can include a solar panel, an inverter, and a node. The inverter can be connected to the solar panel. The node can be connected to the solar panel or the inverter. The node can be configured to mine cryptocurrencies and can generate transactions for a linked distributed ledger network. The solar panel can be mounted to an outside surface of the container. The outside surface of the container can include a roof portion and at least one side portion. The solar panel is mounted to at least one of the roof portion, the at least one side portion, or combinations thereof. The solar panel can be a plurality of solar shingles configured to convert sunlight into direct current electricity. When at least one of the plurality of solar shingles becomes malfunctional, a remaining portion of the plurality of solar shingles can be configured to continue to convert the sunlight into direct current electricity. The container can further include a shelving rack system. The shelving rack system can include a plurality of racks located inside the container. The node can be a plurality of nodes. At least a portion of the plurality of racks can include a series of transformers connected to at least a portion of the plurality of nodes. The linked distributed ledger network can include a cold storage configured to store cryptocurrency mined from the node. At least a portion of the outside surface or an inside portion of the container can include insulation, inlet shutters, cooling pads, fans, or combinations thereof.

Another aspect of the present disclosure provides a system that can include a solar panel and a node. The solar panel can be connected to an outside surface of a container. The node can be electronically connected to the solar panel. The node can include one or more processors and a memory in communication with the one or more processors and storing instructions that, when executed by the one or more processors, can be configured to cause the system to send, to the node, a request to mine a block of a cryptocurrency blockchain. The memory when executed by the one or more processors are further configured to cause the system to receive a block reward in response to the request to mine the block of the cryptocurrency blockchain and store the block reward in a cold wallet storage of a linked distributed ledger network. The memory when executed by the one or more processors can be further configured to cause the system to direct energy collected from the solar panel through an inverter to the node. The container can include a shelving rack system that can include a plurality of racks located inside the container. The node can be a plurality of nodes and at least a portion of the plurality of racks can include a series of transformers connected to at least a portion of the plurality of nodes. The memory when executed by the one or more processors can be further configured to cause the system to generate a graphical user interface (GUI) that can include a bill and a request to pay the bill using an amount of currency stored in the cold wallet storage and transmit the GUI to a user device. The memory when executed by the one or more processors can be further configured to cause the system to receive, from the user device, an affirmative response to the request to pay the bill using the amount of currency stored in the cold wallet storage and send a retrieval request to the linked distributed ledger network to retrieve the amount of currency from the cold wallet storage. The memory when executed by the one or more processors can be further configured to cause the system to receive the amount of currency from the cold wallet storage and send a payment to a bill provider of the bill using the amount of currency received from the retrieval request. The bill can be an equipment bill, a solar bill, an energy bill, a utility bill, a mortgage bill, a loan bill, an insurance bill, or combinations thereof. Sending the payment to a bill provider of the bill using the amount of currency received from the retrieval request can further include sending a retrieval request to the linked distributed ledger network to retrieve the amount of currency from the cold wallet storage and receiving the amount of currency from the cold wallet storage.

The present disclosure will be more fully understood from the following detailed description of embodiments thereof, taken together with the drawings.

### BRIEF DESCRIPTION OF THE FIGURES

Reference now will be made to the accompanying figures, which are not necessarily drawn to scale, and wherein:

FIG. 1 is a perspective view of a container for solar power generation and a linked distributed ledger network in accordance with an embodiment of the present disclosure.

FIG. 2 is a perspective view of a container for solar power generation and a linked distributed ledger network in accordance with an embodiment of the present disclosure.

FIG. 3 is a perspective view of a container for solar power generation and a linked distributed ledger network in accordance with an embodiment of the present disclosure.

FIG. 4 is a perspective view of a container for solar power generation and a linked distributed ledger network in accordance with an embodiment of the present disclosure.

FIG. 5 is a side view of a container for solar power generation and a linked distributed ledger network in accordance with an embodiment of the present disclosure.

FIG. 6 is a side view of a container for solar power generation and a linked distributed ledger network in accordance with an embodiment of the present disclosure.

FIG. 7 is a side view of a container for solar power generation and a linked distributed ledger network in accordance with an embodiment of the present disclosure.

FIG. 8 is a side view of a racking system of a container in accordance with an embodiment of the present disclosure.

FIG. 9 is a side view of a container for solar power generation and a linked distributed ledger network in accordance with an embodiment of the present disclosure.

FIG. 10 is a perspective view of an inside view of a container for solar power generation and a linked distributed ledger network in accordance with an embodiment of the present disclosure.

FIG. 11 is a perspective view of a node for solar power generation in accordance with an embodiment of the present disclosure.

FIG. 12 is an exploded perspective view of a container for solar power generation and a linked distributed ledger network in accordance with an embodiment of the present disclosure.

FIG. 13 is a perspective view of stacked containers for solar power generation and a linked distributed ledger network in accordance with an embodiment of the present disclosure.

FIG. 14 is a front view of a house with a solar power generation system and a linked distributed ledger network in accordance with and embodiment of the present disclosure.

FIGS. 15A and 15B are system diagrams for wind power generation and a linked distributed ledger network in accordance with the present disclosure.

### DETAILED DESCRIPTION

The present disclosure can be understood more readily by reference to the following detailed description of exemplary embodiments and the examples included herein. Before the exemplary embodiments of the devices and methods according to the present disclosure are disclosed and described, it is to be understood that embodiments are not limited to those described within this disclosure. Numerous modifications and variations therein will be apparent to those skilled in the art and remain within the scope of the disclosure. It is also to be understood that the terminology used herein is for describing specific embodiments only and is not intended to be limiting. Some embodiments of the disclosed technology will be described more fully hereinafter with reference to the accompanying drawings. This disclosed technology may, however, be embodied in many different forms and should not be construed as limited to the embodiments set forth therein.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, “a” or “an” can mean one or more, depending upon the context in which it is used. Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

Also, in describing the exemplary embodiments, terminology will be resorted to for the sake of clarity. It is intended that each term contemplates its broadest meaning as understood by those skilled in the art and includes all technical equivalents that operate in a similar manner to accomplish a similar purpose.

To facilitate an understanding of the principles and features of the embodiments of the present disclosure, exemplary embodiments are explained hereinafter with reference to their implementation in an illustrative embodiment. Such illustrative embodiments are not, however, intended to be limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the disclosed technology, for example.

Reference numbers throughout the figures indicate that a particular feature or object is being referred to.

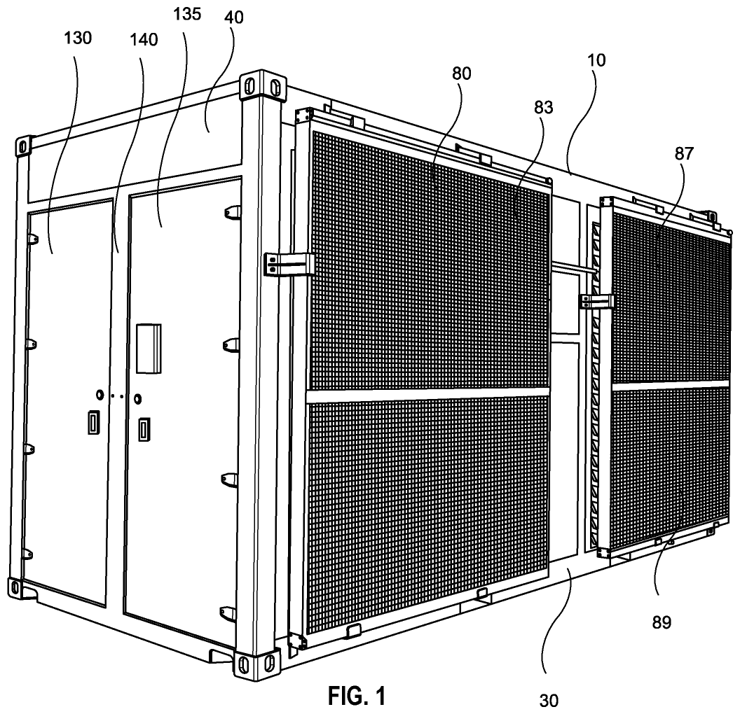

Various devices and methods are disclosed for providing and using a solar power container, and exemplary embodiments of the devices and methods will now be described with reference to the accompanying figures. FIG. 1 is a perspective view of an example solar power container 100 according to an example embodiment of the present disclosure. As can be seen in FIG. 1, an embodiment of the present invention includes a top frame 10, a lower frame 20, two sidewalls 30, 35, and two end walls 40, 45. In some embodiments, at least one of the two end walls 40, 45 can include doors 130, 135 hingeably connected to a door frame 140. In some embodiments, the top frame 10, the lower frame 20, the two sidewalls 30, 35, and the two end walls 40, 45 can have an outside surface. The top frame 10 can have a roof portion and the two sidewalls 30, 35 can be known as side portions.

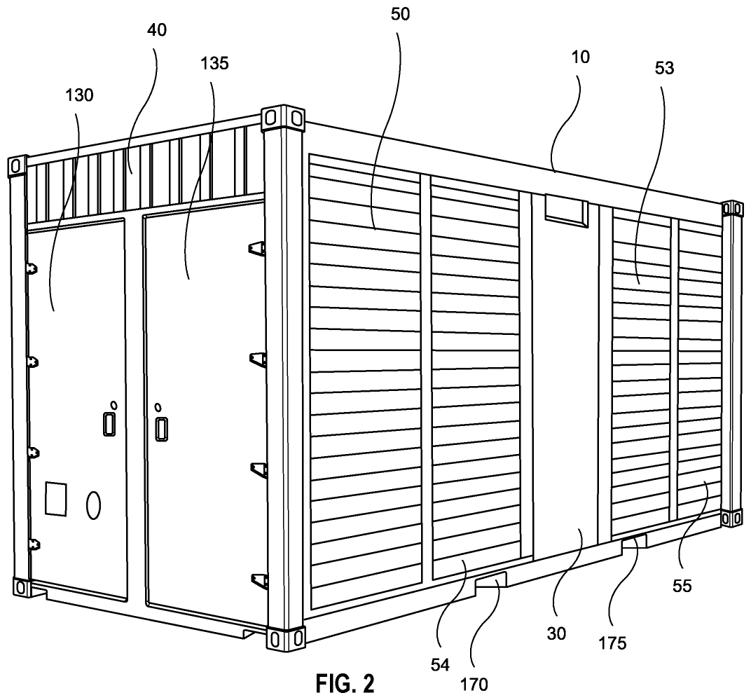

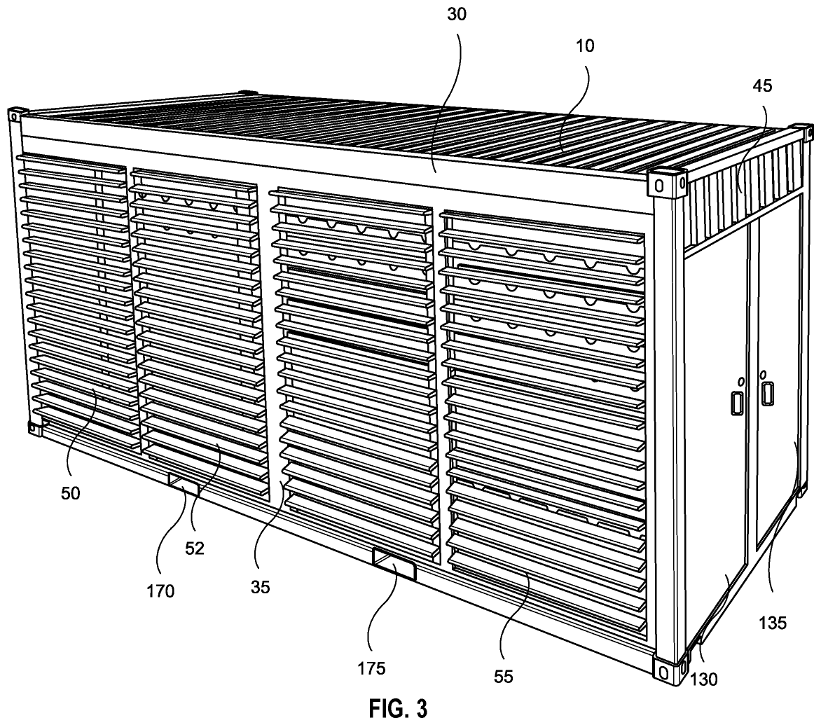

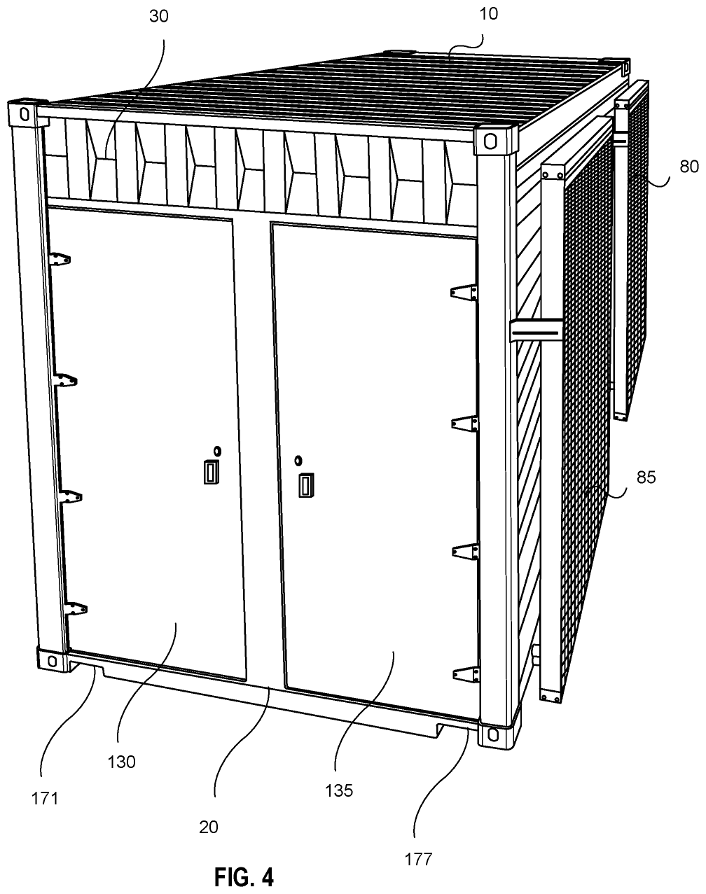

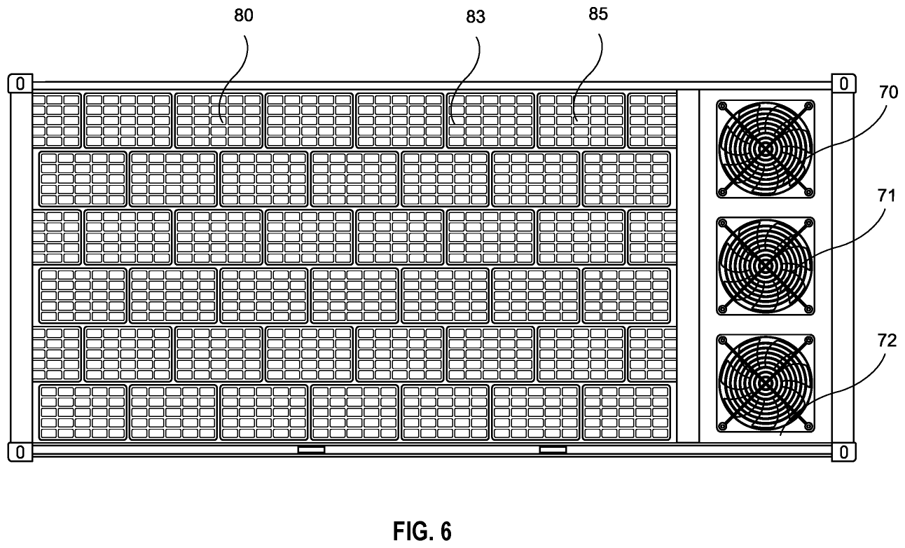

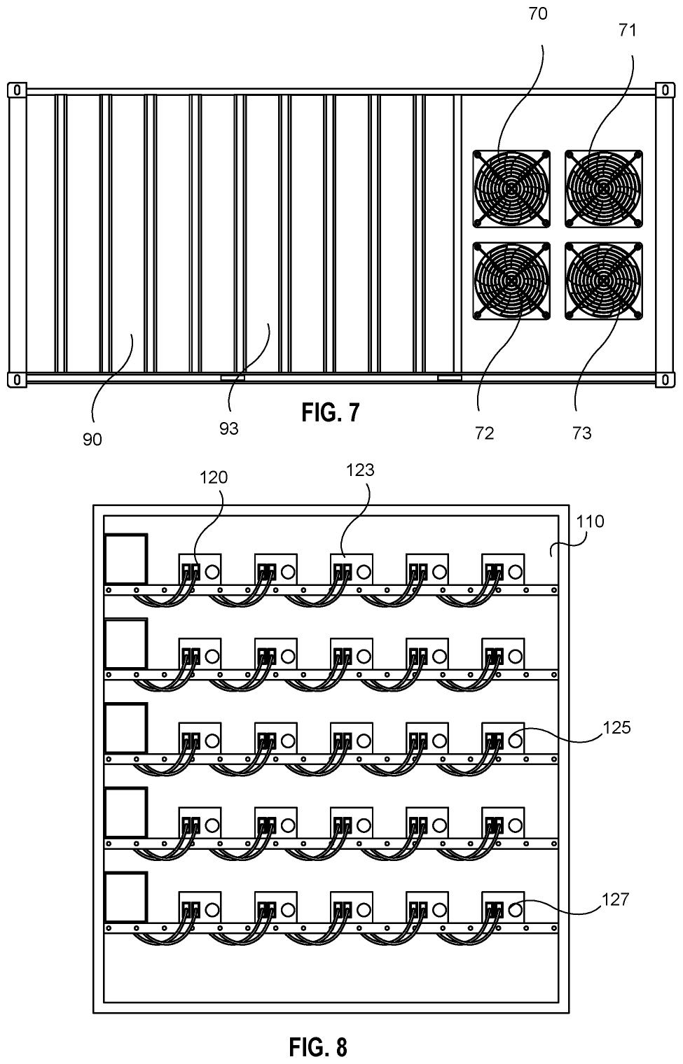

Referring to FIGS. 1, 4 and 6, in some embodiments, at least one of the two sidewalls 30, 35 can include a plurality of solar shingles 80-89. The plurality of solar shingles 80-89 can be configured to convert sunlight into direct current electricity, and when at least one of the plurality of solar shingles 80-89 becomes malfunctional, a remaining portion of the plurality of solar shingles 80-89 can be configured to continue to convert the sunlight into direct current electricity while the malfunctional solar shingles 80-89 remain offline. The solar shingles 80-89 can be more modular. If one of the solar shingles 80-89 has a power issue, the system can continue operation at a higher level compared to if an entire solar panel 50 goes down. Referring to FIGS. 2, 3, and 5, in some embodiments, at least one of the two sidewalls 30, 35 can also include solar panels 50-55. As illustrated in FIG. 2, in some embodiments, the solar power container 100 can be in a closed configuration where the solar panels 50-55 are in a parallel position relative to the two sidewalls 30, 35. As illustrated in FIG. 3, in some embodiments, the solar power container 100 can be in a open configuration where the solar panels 50-55 are in a perpendicular position relative to the two sidewalls 30, 35. At least one of the two sidewalls 30, 35 can include a combination of solar panels 50-55 and/or solar shingles 80-89. Referring to FIG. 7, in some embodiments, at least one of the two sidewalls 30, 35 can also include shutters 90-95.

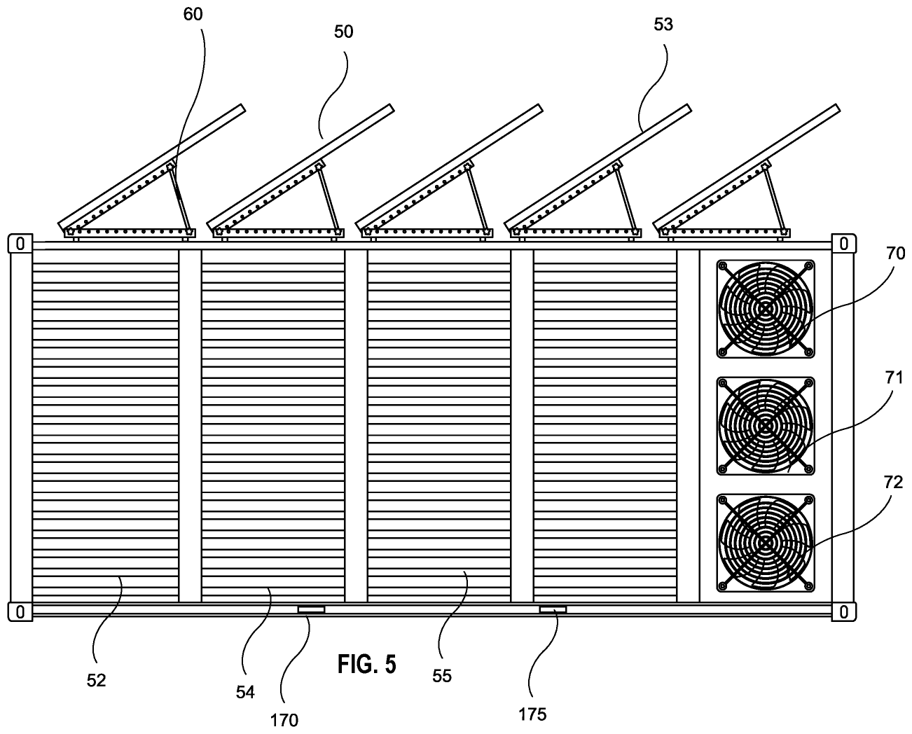

FIG. 5 shows a side view of an example solar power container 100 according to an example embodiment of the present disclosure. As can be seen in FIG. 5, an embodiment of the present invention includes the top frame 10 with solar panels 50-55 attached with adjustable tilt brackets 60-65. In some embodiments, at least one of the two sidewalls 30, 35 can include a plurality of fans 70-23 as illustrated in FIGS. 5-7.

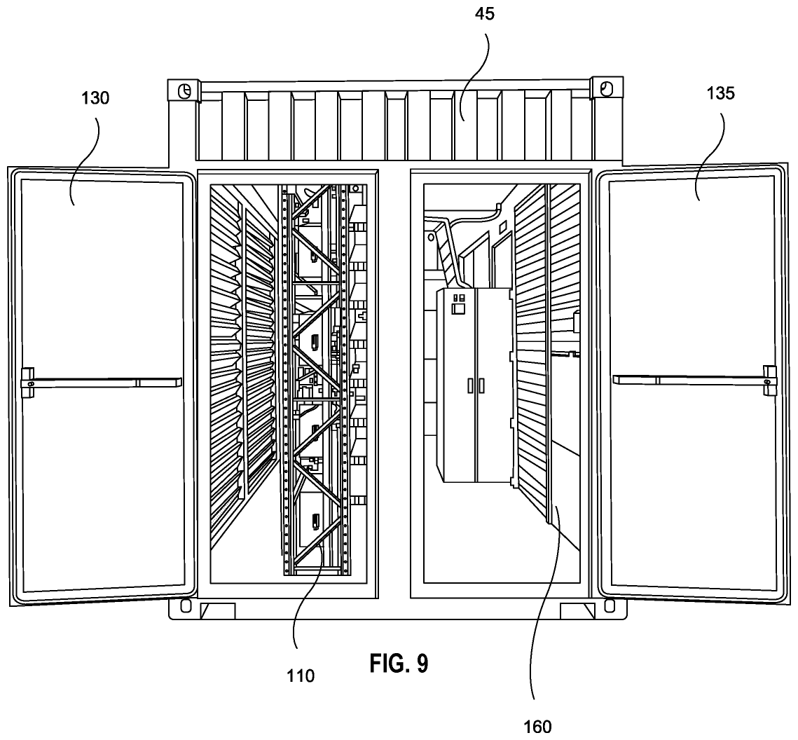

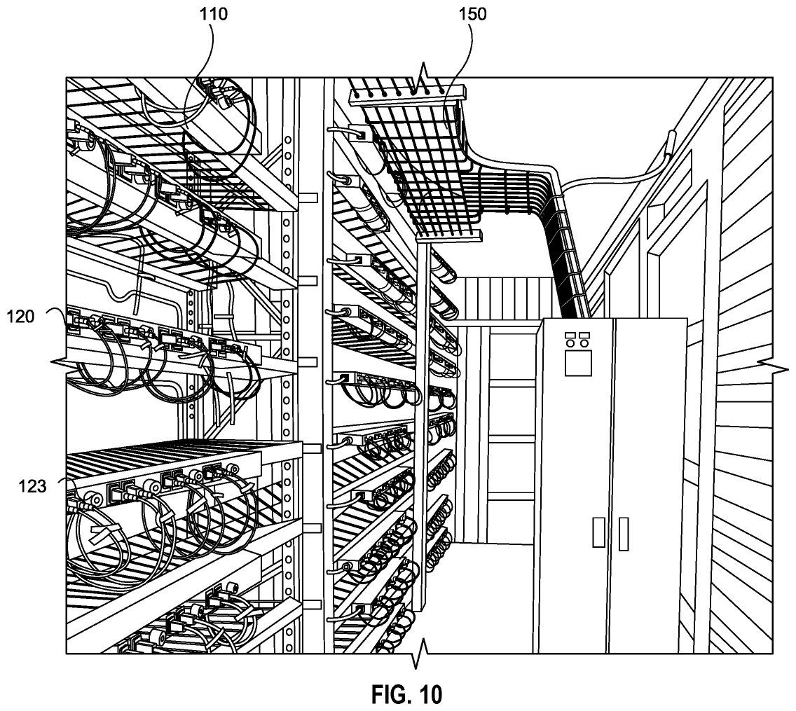

FIG. 8 shows a side view of an example shelving rack system 110 of the solar power container 100, according to an example embodiment of the present disclosure. The shelving rack system 110 can include a plurality of nodes 120-129. In some embodiments, the shelving rack can include a series of transformers and a plurality of inverters. Referring to FIG. 9, the shelving rack 110 can be located between the two sidewalls 30, 35 inside of the solar power container 100. As illustrated in FIG. 10, the shelving rack system 10 can include a plurality of racks, where at least a portion of the plurality of racks include a portion of the plurality of nodes 120-129, transformers, and inverters.

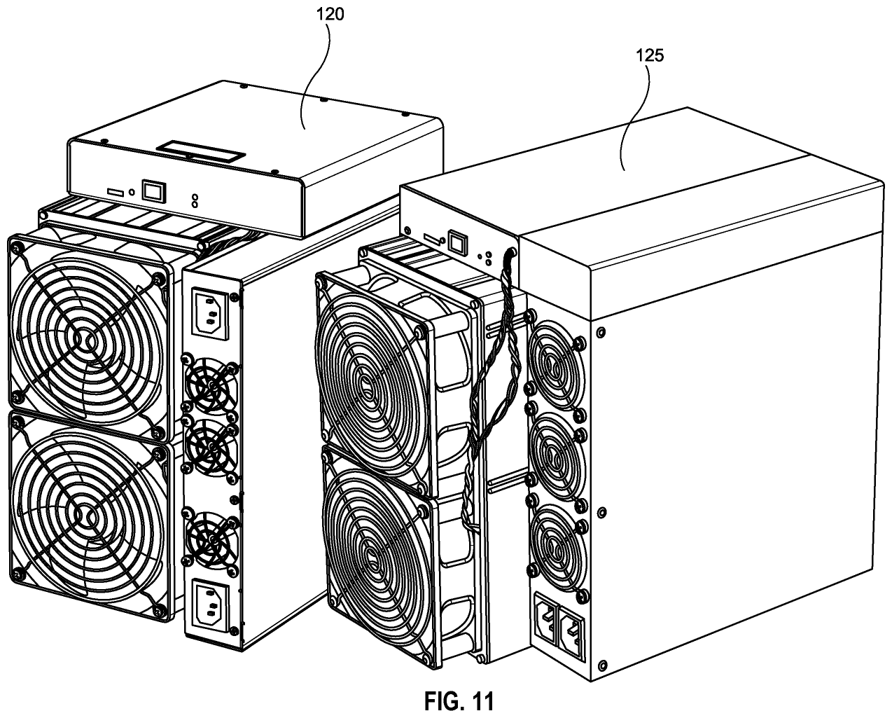

As shown in FIG. 11, the solar power container 100 can have a plurality of nodes 120-129. The plurality of nodes 120-129 can be electronically connected to the plurality of inverters and the series of transformers, which can be electronically connected to the solar panels 50-55. The nodes 120-129 can be installed with inverters in a solar power container 100. The nodes 120-129 can be mounted to the wall or on a shelf in the solar power container 100, or the inverter itself can include the nodes 120-129. In some embodiments, the solar panels 50-55 can be configured to convert sunlight into energy, such as direct current electricity. The plurality of inverters can be configured to convert the direct current electricity from the solar panels 50-55 to alternating current electricity. The series of transformers can be configured to reduce or increase a voltage of the alternating current electricity. The plurality of nodes 120-129 can be configured to generate transactions for a linked distributed ledger network by mining blocks of a blockchain for cryptocurrency or block rewards. The linked distributed ledger network can include a cold storage configured to store cryptocurrency mined from the plurality of nodes. Node stacking is also possible to increase the usage. Node stacking can include using a combination of different types of nodes 120-129 to increase the capacity of the generated transactions for the linked distributed ledger network. The generated transactions can be generated on a monthly basis, which can correspond to the monthly costs associated with power consumption and/or power generation by the disclosed technology.

In some embodiments, the plurality of nodes 120-129 can comprise one or more processors, and a memory in communication with the one or more processors and storing instructions that, when executed by the one or more processors, are configured to cause the system to send, to the nodes 120-129, a request to mine a block of a cryptocurrency blockchain, receive a block reward in response to the request to mine the block of the cryptocurrency blockchain, and store the block reward in a cold wallet storage of a linked distributed ledger network.

In some embodiments, the memory of the plurality of nodes 120-129 when executed by the one or more processors can be further configured to cause the system to generate a graphical user interface (GUI) that can include a bill and a request to pay the bill using an amount of currency stored in the cold wallet storage and transmit the GUI to a user device. The memory when executed by the one or more processors can be further configured to cause the system to receive, from the user device, an affirmative response to the request to pay the bill using the amount of currency stored in the cold wallet storage and send a retrieval request to the linked distributed ledger network to retrieve the amount of currency from the cold wallet storage. The memory when executed by the one or more processors can be further configured to cause the system to receive the amount of currency from the cold wallet storage and send a payment to a bill provider of the bill using the amount of currency received from the retrieval request. The bill can be an equipment bill, a solar bill, an energy bill, a utility bill, a mortgage bill, a loan bill, an insurance bill, or combinations thereof. Sending the payment to a bill provider of the bill using the amount of currency received from the retrieval request can further include sending a retrieval request to the linked distributed ledger network to retrieve the amount of currency from the cold wallet storage and receiving the amount of currency from the cold wallet storage. Because the nodes 120-129 are linked to distributed ledger networks, the nodes 120-129 can participate in any distributed ledger technology besides a blockchain. This includes, but is not limited to, blockchain, cryptocurrency, non-fungible tokens, real rime operating systems, personal identity security programs, and the like.

The memory of the plurality of nodes 120-129 when executed by the one or more processors can be further configured to include programs (scripts, functions, algorithms) to configure data for visualizations and provide visualizations of datasets and data models on the user device. This may include programs to generate graphs and display graphs such as histograms, scatter plots, time series, or the like on the user device. T The memory of the plurality of nodes 120-129 when executed by the one or more processors can be further configured to display properties of data models and data model training results including, for example, architecture, loss functions, cross entropy, activation function values, embedding layer structure and/or outputs, convolution results, node outputs, or the like on the user device.

In other embodiments, the memory of the plurality of nodes 120-129 when executed by the one or more processors can be further configured to cause the system to generate a second graphical user interface (GUI) that can include a request to sell solar energy in the metaverse. The solar energy can be represented as solar panels 50-55 in the NFT/metaverse system or any item that is connected to the related distributed ledger network. For example, the nodes 120-129 does not only have to be a panel, but the nodes 120-129 could also be a stuffed bear, a piece of land, or anything in the NFT space. That solar panel 50-55 or piece of property that is bought can then be tied to a nodes 120-129 that is designated for that customer that will then generate a small amount of income per month to that customer. The customers are able to collect passive income in the meta verse that can be used to buy other items in the crypto/NFT space.

Current testing shows that nodes 120-129 can generate between $250 and $500 a month in passive cryptocurrency mining that can be used to offset the costs of a solar power generation system, other power bills, investments, and the like. The presently disclosed nodes 120-129 can be operated in a residential or commercial setting. For larger facilities with greater surface area and/or areas of high internet traffic, the disclosed technology can generate between $1000 and $1500 per month in passive cryptocurrency mining.

The problem to be solved is the cost and return on investment (ROI) limitations for solar power generation. The high costs of solar power fall on the purchasing customer or the solar power leasing party. The offset gained from the disclosed technology can offset the operating costs of such systems, making solar power generation more affordable. The customer can also have easier access to distributed ledger systems. The customer can use the nodes 120-129 to trade and exchange cryptocurrencies from the location of their solar power generation system to be used as payments for bills as outlined above.

For companies leasing solar power generation systems, the offset gained from the disclosed technology can allow for expedited ROI on the principal investment in material and labor costs for the units allowing the companies to become cash positive. Companies can become cash positive on units in a quarter of the time, which solves the current massive loss leader gap that has put such companies in the negative.

Using the distributed ledger technology can allow users to use mined cryptocurrency as a form of loan repayment. Specifically, the disclosed systems can allow the homeowner or individual users of the disclosed systems to remit loan payments via crypto or other currency generated from the nodes 120-129. The disclosed systems can also include a process of transferring or converting the currency mined and/or collected from the nodes 120-129. Additionally, for the application of a mortgage repayment on homes and/or businesses, the disclosed systems can utilize the nodes 120-129 and distributed ledger technology to make payments. Furthermore, the disclosed systems can use the nodes 120-129 and distributed ledger technology to offset any payback periods, increase ROI, decrease interest, and/or make deposits and payments.

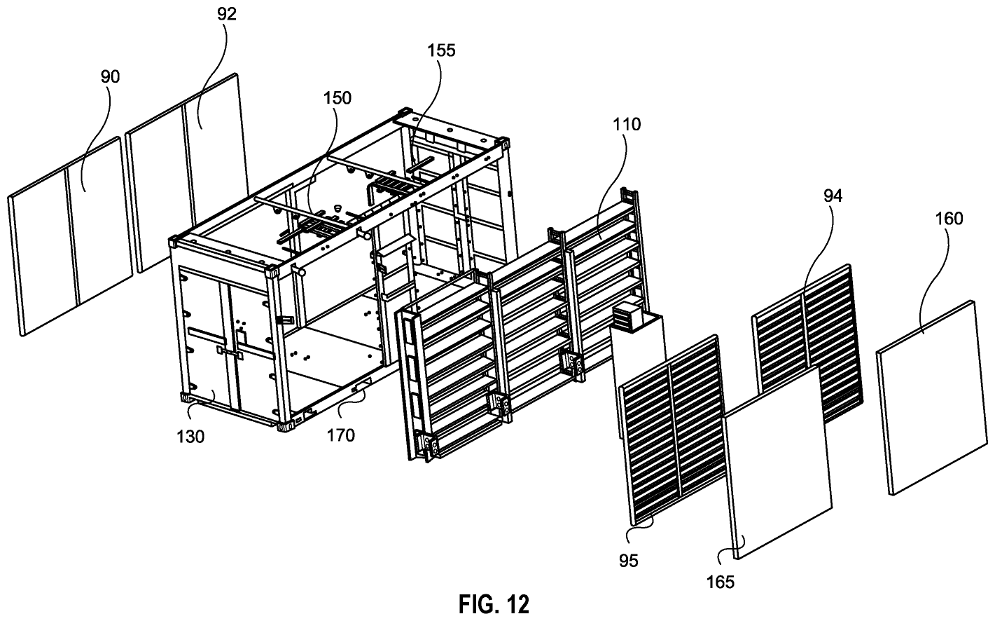

FIG. 12 is an exploded view of an example solar power container 100 according to an example embodiment of the present disclosure. As can be seen in FIG. 12, an embodiment of the solar power container 100 can further include outlet shutters 90-93 connected to at least one of the two sidewalls 30, 35. The top frame 10 can include a lighting system 150, 155 as well.

Additionally, at least one of the two sidewalls 30, 35 can be connected to inlet shutters 94-95 and cooling pads 160, 165. In some embodiments, at least a portion of the outside surface or an inside portion of the solar power container 100 can include insulation, inlet shutters 94, 95, cooling pads 160, 165, fans 70-73, or combinations thereof.

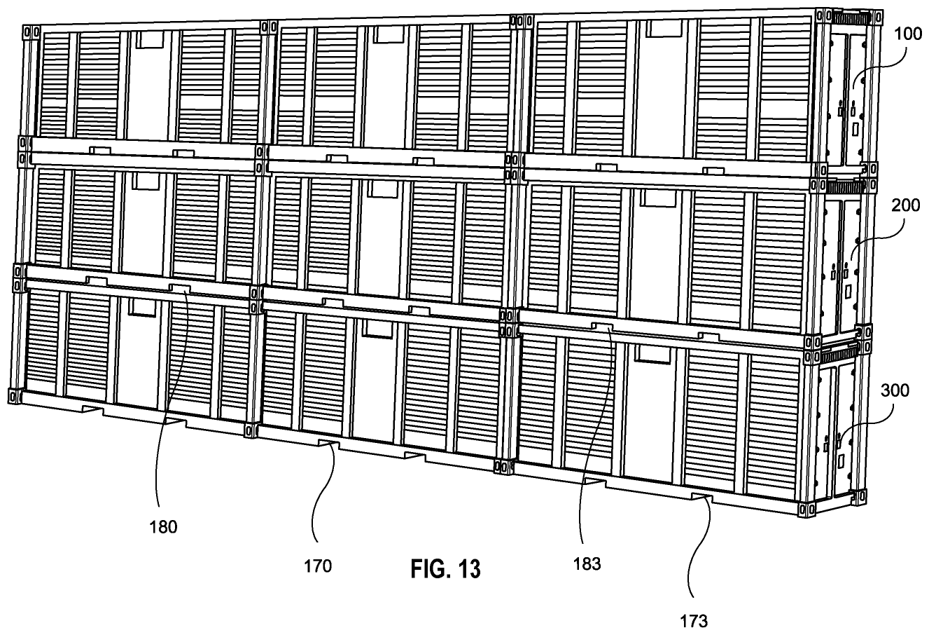

Referring to FIG. 13, in some embodiments, the solar power container 100 can be a part of a plurality of solar power containers. The lower frame 20 of the solar power container 100 can include apertures 170-179. A top frame 10 of a second solar power container 200 can include upward facing tabs 180-189. The apertures 170-179 of the solar power container 100 can be positioned to engage with the upward facing tabs 180-189 of the second solar power container 200. The apertures 170-179 that engage with the upward facing tabs 180-189 can assist in keeping the solar power container 100 and the second solar power container 200 in a secured position and can also assist in helping stack the plurality of solar power containers 100, 200, 300 on top of one another. The solar power container 100 can further be outfitted to be movable. The solar power container 100 can be picked up and relocated. The solar power container 100 can range from 8×8 ft in size to 40×8 ft traditional shipping crate sizes. The size of the solar power container 100 can be altered based on the specific needs of the user and the space available.

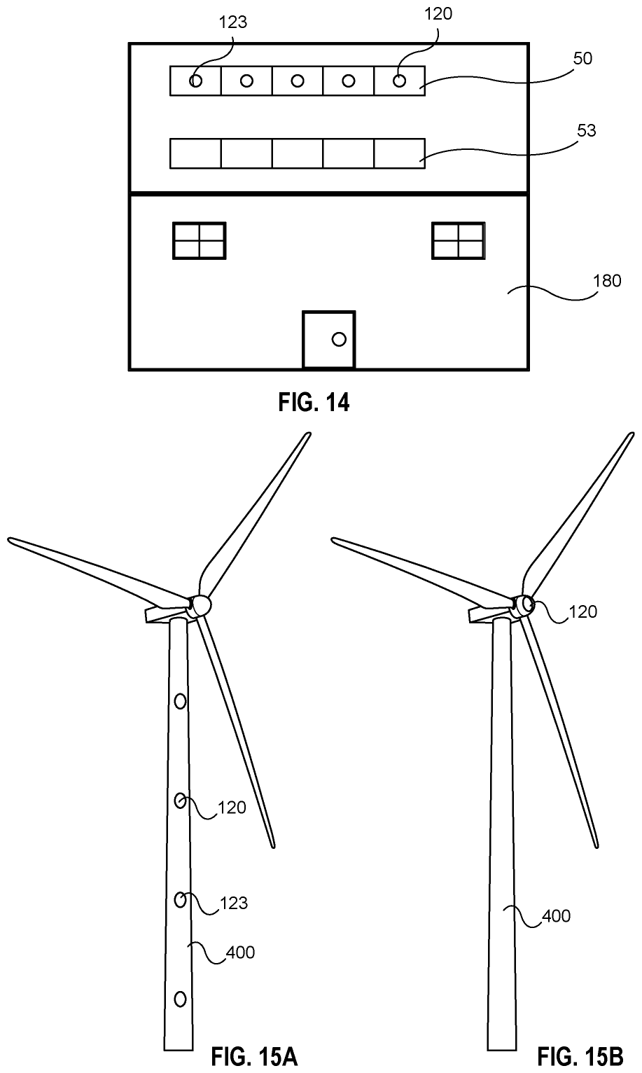

As shown in FIG. 14, the disclosed systems can also be linked to a roof of a house 310. The plurality of nodes 120-129 can be connected on the roof of the house 310. As such, the integrated nodes 120-129 could be free from the possibility of tampering, striking, accidents, and the like. As outlined above, the plurality of nodes 120-129 can comprise one or more processors, and a memory in communication with the one or more processors and storing instructions that, when executed by the one or more processors, are configured to cause the system to send, to the nodes 120-129, a request to mine a block of a cryptocurrency blockchain, receive a block reward in response to the request to mine the block of the cryptocurrency blockchain, and store the block reward in a cold wallet storage of a linked distributed ledger network. Additionally, the plurality of nodes 120-129 can communicate with a user device using a graphical user interface (as outlined above and not repeated herein for brevity).

As shown in FIGS. 15A and 15B, the present technology can also be implemented into wind turbine 400 energy systems in addition to solar power generation systems. The wind turbines 400 can include the plurality of nodes 120-129 which can communicate with a user device using a graphical user interface and can function as outlined above (not repeated herein for brevity).

In other embodiments, the disclosed systems can also be linked to independent internet satellites. The nodes 120-129 can have receivers and the nodes 120-129 and receivers can be built into the solar panels 50-55 themselves. In such a manner, the nodes 120-129 can have uninterrupted connection to the distributed ledger network without suffering internet loss. Furthermore, the ability to collect cryptocurrency or the connection to the blockchain can be uninterrupted. The disclosed systems can further include a power supply, such as a battery, to provide power when the solar power generation is not working (e.g., at night).

In other embodiments, the solar power container 100 can be attached to a solar field. The solar power container 100 can be compatible with all forms of alternative energy and traditional grid power included but not limited to, solar, wind, off gas, grid, or water generated energy production at the commercial and residential level.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

Aspects of the invention are also provided by the following numbered clauses:

Clause 1: A container comprising: a top frame; a lower frame; two sidewalls, each sidewall connected to one of the top frame or the lower frame; and a rack, the rack located between the two sidewalls and connected to one of the top frame or the lower frame, wherein at least one of the top frame, the two sidewalls, or combinations thereof comprise a solar panel, and wherein the rack comprises a node configured to mine cryptocurrencies.

Clause 2: The container of clause 1, wherein the solar panel is mounted to at least one of the top frame, one of the two sidewalls, or combination thereof, and wherein the solar panel configured to convert sunlight into direct current electricity.

Clause 3: The container of clause 2, further comprising a plurality of inverters configured to convert the direct current electricity from the solar panel to alternating current electricity.

Clause 4: The container of clause 3, wherein the node is a plurality of nodes and the plurality of nodes are configured to generate transactions for a linked distributed ledger network.

Clause 5: The container of clause 4, wherein at least a portion of the plurality of nodes are attached to at least one of the two sidewalls, the rack, the plurality of inverters, or combinations thereof.

Clause 6: The container of clause 4, wherein the linked distributed ledger network comprises a cold storage configured to store cryptocurrency mined from the plurality of nodes.

Clause 7: The container of clause 1, further comprising two end walls, wherein each end wall is connected to one of the top frame or the lower frame, and wherein at least one of the end walls comprise the solar panel, a door hingeably connected to a door frame of at least one of the end walls, fans, or combinations thereof.

Clause 8: The container of clause 7, wherein at least one of the top frame, the two sidewalls, the two end walls, or combinations thereof further comprise insulation, inlet shutters, cooling pads, fans, or combinations thereof.

Clause 9: A container comprising: a solar panel; an inverter, the inverter connected to the solar panel; and a node connected to the solar panel or the inverter, the node configured to mine cryptocurrencies and to generate transactions for a linked distributed ledger network, wherein the solar panel is mounted to an outside surface of the container.

Clause 10: The container of clause 9, wherein the outside surface of the container comprise a roof portion and at least one side portion, and wherein the solar panel is mounted to at least one of the roof portion, the at least one side portion, or combinations thereof.

Clause 11: The container of clause 10, wherein the solar panel is a plurality of solar shingles configured to convert sunlight into direct current electricity, and wherein when at least one of the plurality of solar shingles becomes malfunctional, a remaining portion of the plurality of solar shingles is configured to continue to convert the sunlight into direct current electricity.

Clause 12: The container of clause 10, further comprising a shelving rack system comprising a plurality of racks located inside the container, wherein the node is a plurality of nodes, and wherein at least a portion of the plurality of racks comprise a series of transformers connected to at least a portion of the plurality of nodes.

Clause 13: The container of clause 9, wherein the linked distributed ledger network comprises a cold storage configured to store cryptocurrency mined from the node.

Clause 14: The container of clause 9, wherein at least a portion of the outside surface or an inside portion of the container comprise insulation, inlet shutters, cooling pads, fans, or combinations thereof.

Clause 15: A system comprising: a solar panel, the solar panel connected to an outside surface of a container; a node electronically connected to the solar panel, the node comprising: one or more processors; and a memory in communication with the one or more processors and storing instructions that, when executed by the one or more processors, are configured to cause the system to: send, to the node, a request to mine a block of a cryptocurrency blockchain; receive a block reward in response to the request to mine the block of the cryptocurrency blockchain; and store the block reward in a cold wallet storage of a linked distributed ledger network.

Clause 16: The system of clause 15, wherein the memory when executed by the one or more processors are further configured to cause the system to: direct energy collected from the solar panel through an inverter to the node.

Clause 17: The system of clause 15, wherein the container comprises a shelving rack system comprising a plurality of racks located inside the container, wherein the node is a plurality of nodes, and wherein at least a portion of the plurality of racks comprise a series of transformers connected to at least a portion of the plurality of nodes.

Clause 18: The system of clause 15, wherein the memory when executed by the one or more processors are further configured to cause the system to: generate a graphical user interface (GUI) comprising a bill and a request to pay the bill using an amount of currency stored in the cold wallet storage; transmit the GUI to a user device; receive, from the user device, an affirmative response to the request to pay the bill using the amount of currency stored in the cold wallet storage; send a retrieval request to the linked distributed ledger network to retrieve the amount of currency from the cold wallet storage; receive the amount of currency from the cold wallet storage; and send a payment to a bill provider of the bill using the amount of currency received from the retrieval request.

Clause 19: The system of clause 18, wherein the bill is an equipment bill, a solar bill, an energy bill, a utility bill, a mortgage bill, a loan bill, an insurance bill, or combinations thereof.

Clause 20: The system of clause 18, wherein sending the payment to a bill provider of the bill using the amount of currency received from the retrieval request further comprises: sending a retrieval request to the linked distributed ledger network to retrieve the amount of currency from the cold wallet storage; and receiving the amount of currency from the cold wallet storage.

It is to be understood that the mention of one or more method steps does not preclude the presence of additional method steps or intervening method steps between those steps expressly identified. It is also to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the public, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

What is claimed is:

1. A solar power generation system comprising:
a top frame;
a lower frame;
two sidewalls, each sidewall connected to one of the top frame or the lower frame; and
a rack, the rack located between the two sidewalls and connected to one of the top frame or the lower frame,
wherein at least one of the top frame, the two sidewalls, or combinations thereof comprise a solar panel, and
wherein the rack comprises a node configured to mine cryptocurrencies.

2. The system of claim 1, wherein the solar panel is mounted to at least one of the top frame, one of the two sidewalls, or combination thereof, and wherein the solar panel configured to convert sunlight into direct current electricity.

3. The system of claim 2, further comprising a plurality of inverters configured to convert the direct current electricity from the solar panel to alternating current electricity.

4. The system of claim 3, wherein the node is a plurality of nodes and the plurality of nodes are configured to generate transactions for a linked distributed ledger network.

5. The system of claim 4, wherein at least a portion of the plurality of nodes are attached to at least one of the two sidewalls, the rack, the plurality of inverters, or combinations thereof.

6. The system of claim 4, wherein the linked distributed ledger network comprises a cold storage configured to store cryptocurrency mined from the plurality of nodes.

7. The system of claim 1, further comprising two end walls, wherein each end wall is connected to one of the top frame or the lower frame, and wherein at least one of the end walls comprise the solar panel, a door hingeably connected to a door frame of at least one of the end walls, fans, or combinations thereof.

8. The system of claim 7, wherein at least one of the top frame, the two sidewalls, the two end walls, or combinations thereof further comprise insulation, inlet shutters, cooling pads, fans, or combinations thereof.

9. A solar power generation system comprising:
a solar panel;
an inverter, the inverter connected to the solar panel; and
a node connected to the solar panel or the inverter, the node configured to mine cryptocurrencies and to generate transactions for a linked distributed ledger network,
wherein the solar panel is mounted to an outside surface of the container.

10. The system of claim 9, wherein the outside surface of the container comprise a roof portion and at least one side portion, and wherein the solar panel is mounted to at least one of the roof portion, the at least one side portion, or combinations thereof.

11. The system of claim 10, wherein the solar panel is a plurality of solar shingles configured to convert sunlight into direct current electricity, and wherein when at least one of the plurality of solar shingles becomes malfunctional, a remaining portion of the plurality of solar shingles is configured to continue to convert the sunlight into direct current electricity.

12. The system of claim 10, further comprising a shelving rack system comprising a plurality of racks located inside the container,
wherein the node is a plurality of nodes, and
wherein at least a portion of the plurality of racks comprise a series of transformers connected to at least a portion of the plurality of nodes.

13. The system of claim 9, wherein the linked distributed ledger network comprises a cold storage configured to store cryptocurrency mined from the node.

14. The system of claim 9, wherein at least a portion of the outside surface or an inside portion of the container comprise insulation, inlet shutters, cooling pads, fans, or combinations thereof.

15. A solar power generation system comprising:
a solar panel, the solar panel connected to an outside surface of a container;
a node electronically connected to the solar panel, the node comprising:
one or more processors; and
a memory in communication with the one or more processors and storing instructions that, when executed by the one or more processors, are configured to cause the system to:
send, to the node, a request to mine a block of a cryptocurrency blockchain;
receive a block reward in response to the request to mine the block of the cryptocurrency blockchain; and
store the block reward in a cold wallet storage of a linked distributed ledger network.

16. The system of claim 15, wherein the memory when executed by the one or more processors are further configured to cause the system to:
direct energy collected from the solar panel through an inverter to the node.

17. The system of claim 15, wherein the container comprises a shelving rack system comprising a plurality of racks located inside the container,
wherein the node is a plurality of nodes, and
wherein at least a portion of the plurality of racks comprise a series of transformers connected to at least a portion of the plurality of nodes.

18. The system of claim 15, wherein the memory when executed by the one or more processors are further configured to cause the system to:
generate a graphical user interface (GUI) comprising a bill and a request to pay the bill using an amount of currency stored in the cold wallet storage;
transmit the GUI to a user device;
receive, from the user device, an affirmative response to the request to pay the bill using the amount of currency stored in the cold wallet storage;
send a retrieval request to the linked distributed ledger network to retrieve the amount of currency from the cold wallet storage;
receive the amount of currency from the cold wallet storage; and
send a payment to a bill provider of the bill using the amount of currency received from the retrieval request.

19. The system of claim 18, wherein the bill is an equipment bill, a solar bill, an energy bill, a utility bill, a mortgage bill, a loan bill, an insurance bill, or combinations thereof.

20. The system of claim 18, wherein sending the payment to a bill provider of the bill using the amount of currency received from the retrieval request further comprises:
sending a retrieval request to the linked distributed ledger network to retrieve the amount of currency from the cold wallet storage; and
receiving the amount of currency from the cold wallet storage.
